(19) United States
(12) Patent Application Publication
(10) Pub. No.: US 2020/0143483 A1
(43) Pub. Date: May 7, 2020

(54) Lost and Found Matchmaking Notification System for Items Based on User Profile Settings and Location of the Item

(71) Applicant: Shedaun P. Smith, Woodbridge, VA (US)

(72) Inventor: Shedaun P. Smith, Woodbridge, VA (US)

(21) Appl. No.: 16/179,961

(22) Filed: Nov. 4, 2018

(51) Int. Cl. G06Q 50/00; H04L 29/08; H04L 12/58

(52) U.S. Cl. CPC G06Q 50/01; H04L 51/04; H04L 67/26

(57) ABSTRACT

A methodology that supports the production of automated matchmaking results and notification for lost and found items based on the item type and last known location of the lost item or found item. Users, who either have lost or have found an item, create a profile by identifying who they are in relation to the item, the item type, and the location of where the item was lost or found. This information is stored in a database maintained by a server where it is processed through matchmaking program code. The program code identifies user matches. The matches are then sent as notifications to matched users of the Lost and Found Matchmaking Notification System (“System”). Notifications are sent through email and through push notification for downloaded mobile or tablet applications versions of the System. After notification, matched users then can communicate with each other inside the system through in-system messaging.

### BACKGROUND OF THE INVENTION

Common issues that all people share are forgetting, leaving, and losing items. We leave jackets and umbrellas at coffee shops. We forget sunglasses and keys on public transportation. A significant amount of items that we lose do not have tracking devices on them. Additionally, a significant amount of people search for a limited time before assuming that the item will never be recovered. As a result, people spend significant amounts of money in their lifetime replacing lost items. When using social media and classified websites to attempt to recover lost items, the lost and found postings can be lost in a sea of content. One has to wait and hope if someone notices the posting and hope that the person viewing the post has the inclination to respond in contrast to the following described embodiments that disclose a system designated for lost and found items and that automatically matches users who have lost and found items in a common and specified location radius to users who have found similar items in that same location radius. This system also allows the finders of lost items to be proactive in returning the item by allowing finders of lost items to post the items instead of just being responsive to a lost item posting, which facilitates a more speedy return of the lost item.

### SUMMARY

A Lost and Found Matchmaking Notification System (“System”) that supports the production of automated matchmaking results and notifications to users who have lost and found items based on the item type and last known location of the lost item or where the item was found. The lost and found match is determined by complementary user logic in the System's program code and the mutually inclusive location area of where the item was lost and where the item was found. Users cannot establish themselves independent of losing or finding an object. The lost and found item and the type of user are combined, creating a “user-item relationship”. The user is identified as a person who lost a certain item or a person who has found (“finder of”) a certain item. Examples of the user- item relationships are a person who has lost keys, or a finder of keys; a person who has lost a wallet, or a finder of a wallet; a person who has lost jewelry, or a finder of jewelry.

In addition to the coordination of complementary user item relationships is the key variable of location. For example, a user who believes they have lost their keys in Kansas City, Mo. should not receive a superfluous match to a user who has found keys in Washington, D.C.. Furthermore, the location variable is not based on where the user lives or where the user is located at the moment of using the System. Therefore, GPS tracking is not relevant to the functioning of the system. The location variable in the System is a reflection of where the item was believed to be lost or where the item was found. For example, a user who believes they have lost their keys around Richmond, Virginia, but is located in Washington D.C. is not matched with a user who has found keys around Bethesda, Maryland but is also located Washington D.C. The user who lost their keys around Richmond, Va. is matched with a user who has found keys around Richmond, Va.

In the Lost and Found Matchmaking Notification System, location is defined by city. A default radius is applied to the location when users perform an initial registration into the System to aid in the uncertainty of where the item was lost. This is helpful if a user is not sure if the lost item is in a certain city, the radius will include all matched users within the location circumference established by the city and the default radius. Users can change the city and search radius within their settings section in their user-interface of the System. The city is defined by longitude and latitude coordinates stated by The National Aeronautics and Space Administration (NASA).

To be notified of matched users, a user must enter in their user-item relationship and the location of the lost item or the location of where the item was found. The entered information is sent through the System's program code in the server to generate user- item complementary results (matches). Notification of the matches are sent to all users included in matches: the user who initiated the inquiry and resulting matched users of the inquiry. The System gives the option of notification to be sent through email and through push notification on the matched users mobile devices and tablet computers.

The System displays the list of matched users in the match results section of the the user-interface. To confirm the lost or found item, the users choose the profile picture of the matched users to view the user profile. The user profile details particular circumstances in which the item was lost or found. This is ideal for confirming information for a matched user on the missing or found item such as color, fabric, designer, or exact location of where the item was lost of found such as a particular venue, store, or restaurant. This information is stated in the “detailed item” section of the user profile.

In a preferred embodiment, the user is able to contact the matched users by in-system messaging. A notification is created and sent to the receiving matched user that a message has been sent to them, and receiving user can respond accordingly.

In embodiment, the profile allows uploading of item pictures. Additionally, users can hide item photos if they wish for matched users to prove their ownership or possession of an item by requesting the matched users disclose certain details of the item that only the owners or possessors of the item would know. At their discretion, users can permit access to the photo for item confirmation.

### BRIEF DESCRIPTION OF THE FIGURES

FIG. 1 depicts an exemplary environment in which the lost and found matchmaking system is utilized according to an embodiment of the present disclosure.

FIG. 2 illustrates a diagram of the flow of data that is inputted into the System by users and processed by the server to generate and send lost and found item notifications in accordance with an embodiment of the present disclosure.

FIG. 3 is a flow diagram on how the data of User-1, who is searching for a lost item, is processed through the server, which utilizes matchmaking logic, location radius criteria, and user notification preferences, to generate match results and send notifications to matched users in accordance with an embodiment of the present disclosure.

FIG. 4 is a flow diagram on how the data of User-2, who has found a lost item, is processed through the server, which utilizes matchmaking logic , location radius criteria ,and user notification preferences to generate match results and send notifications to matched users in accordance with an embodiment of the present disclosure.

FIG. 5 shows an exemplary user interface on a mobile device entering necessary lost item data in accordance with an embodiment of the present disclosure.

FIG. 6 shows an exemplary user interface on a mobile device entering necessary found item data in accordance with an embodiment of the present disclosure.

FIG. 7 shows an exemplary output of match notification from the Server to the user interface of the user who has lost an item and has been matched with a user who has found that said item within the location area. A match list is generated by the server and then sent to the user interface for User-1 to view. The user then has the ability to view matched users' profile to confirm match in accordance with an embodiment of the present disclosure.

FIG. 8 shows an exemplary output of match notification from the server to the user interface of a user who has found an item and has been matched with users who have lost that said item. A match list is generated by the server and then sent to the user interface for User-2 to view. The user then has the ability to view matched users' profile to confirm match in accordance with an embodiment of the present disclosure.

FIG. 9 shows an exemplary user interface in which users can contact each other through in-system messaging in accordance with an embodiment of the present disclosure.

FIG. 10 shows an exemplary user interface in which a user who has found or lost an item can maintain private pictures of the item in their profile for confirmation of the identity of the the owner or possessor of the item in accordance with an embodiment of the present disclosure.

FIG. 11 displays how users can edit their search criteria and the mode at which they receive notification from the System after establishing an initial profile with an embodiment of the present disclosure.

### DETAILED DESCRIPTION

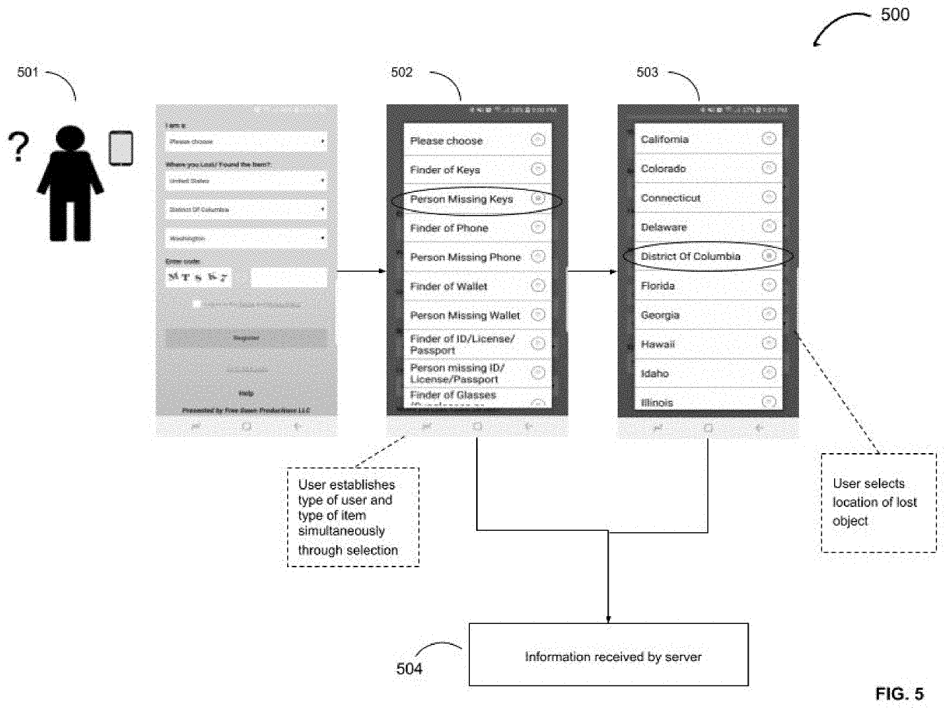

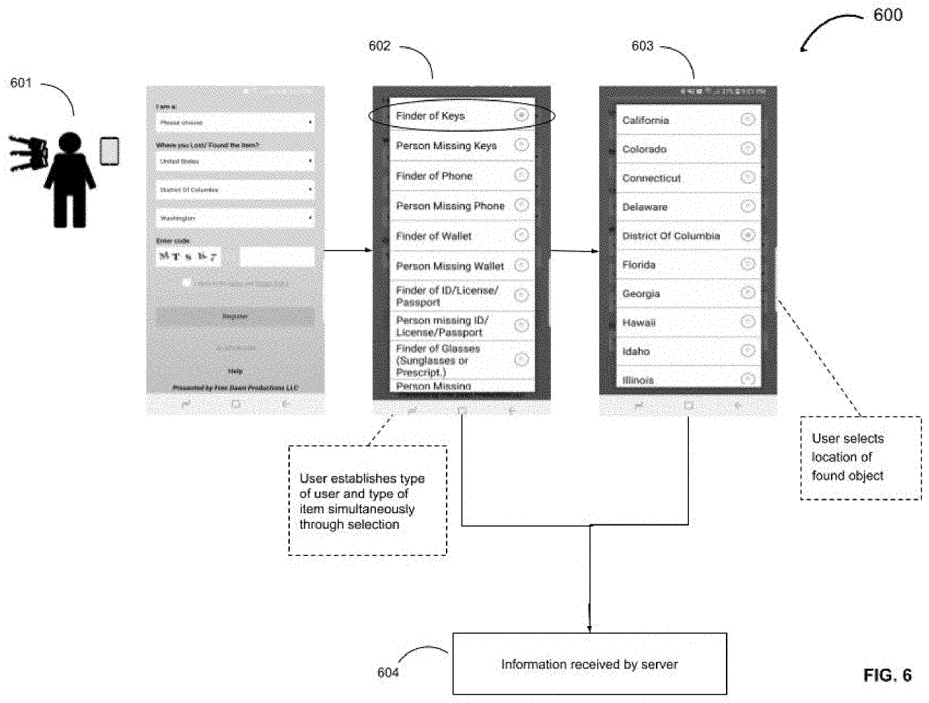

As used herein, the term “user” refers to a person who has lost an item or a person who has found an item. Companies, venues and other establishments may also utilize the lost and found matchmaking system to post found items and receive match notifications. Therefore, they can be referred to as a “user”. In the Lost and Found Matchmaking Notification System, the user not only is identified by what type of user they are, but by the specific category of item that the user has lost or found . Thus, a user cannot be a person who has just lost or found. Users must associate themselves with a lost or found item such as user who has lost keys, or a user who has found keys, or user who has lost a wallet or a user who has found a wallet. This creates a relationship between the user type and the item type, and will be referred to as the user-item relationship. Along with item location and location radius, the user-item relationship is key to the matchmaking logic performed in the server as program code. This process will be addressed again in FIG. 5 and FIG. 6.

In one embodiment, a user that has found an item may initiate the lost and found matchmaking process by entering in information the Lost and Found Matchmaking Notification System. The user will be matched with other users who have lost similar items within the search location radius.

Further, the term “items” as used herein is limited to non living objects. Animals are excluded from lost items in the Lost and Found Matchmaking Notification System. Examples of items that the System includes are things such as keys, phones, wallets, glasses, jewelry, hats, etc. The following disclosure uses keys as an exemplary item.

The following detailed description reflects figures of the system and its functions in respect to two users. It should be noted that the System can successfully match multiple users to one user or multiple users to other multiple users. Thus, for purposes of simplifying the description of the process of the System, two users will be exhibited.

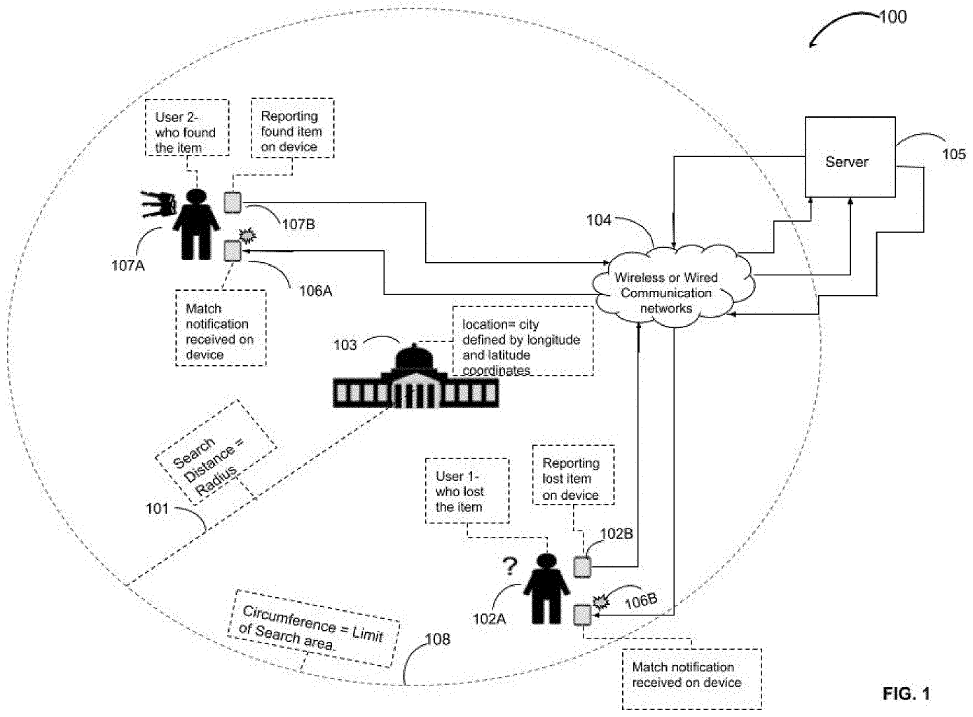

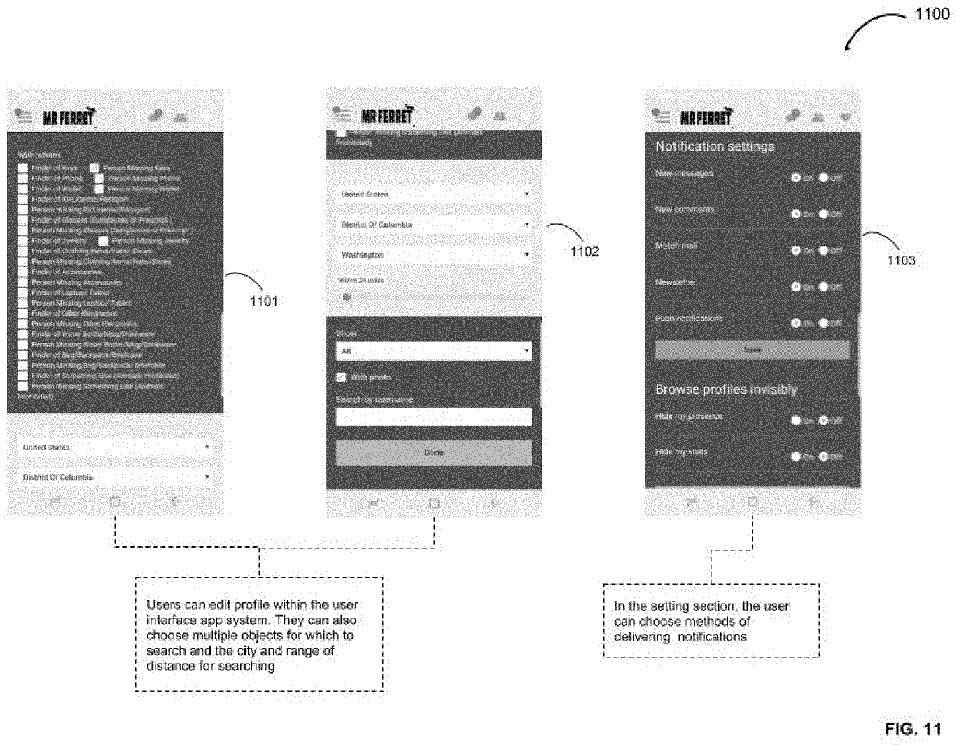

FIG. 1 is an exemplary environment in which the lost and found matchmaking system is utilized according to an embodiment of the present disclosure. The exemplary environment 100 only includes users as potential matches within a predetermined set location radius 101. This radius defines a search area limit 108. User-1 102A has lost their keys. In User-1's device 102B, the user enters the user-item relationship of what type of user they are in combination with the type of item that is lost and the location the item was lost. In certain embodiments, the device shown may represent a smartphone, tablet computer, laptop, or wearable smart technology. During initial entering of information, a set radius of location search is preset by the System. The location 103 is defined by city names. Cities are defined by longitude and latitude coordinates disclosed by NASA. Location and radius can be changed after User-1 enters in the necessary data to create a preliminary profile that has the ability to match with other users. This process is addressed in FIG. 11.

The information is sent through wired or wireless communication networks 104 to a server 105 that processes the information and creates lost and found match notifications. The match notifications are sent to both User-1 106A and User-2 1068 . User-2 who has found the keys 107A needs to have had already inputted the found item information into the lost and found matchmaking system in order for the match to be created and consequently match notifications to be sent to their device 1078. If there are no immediate matches available within the search criteria, the information is logged and kept in the server unless the user changes the user-item relationship or search city and radius. The updated information is then logged and kept in the server, and the server will create and send as lost and found match notification when a users are within the criteria to create a match.

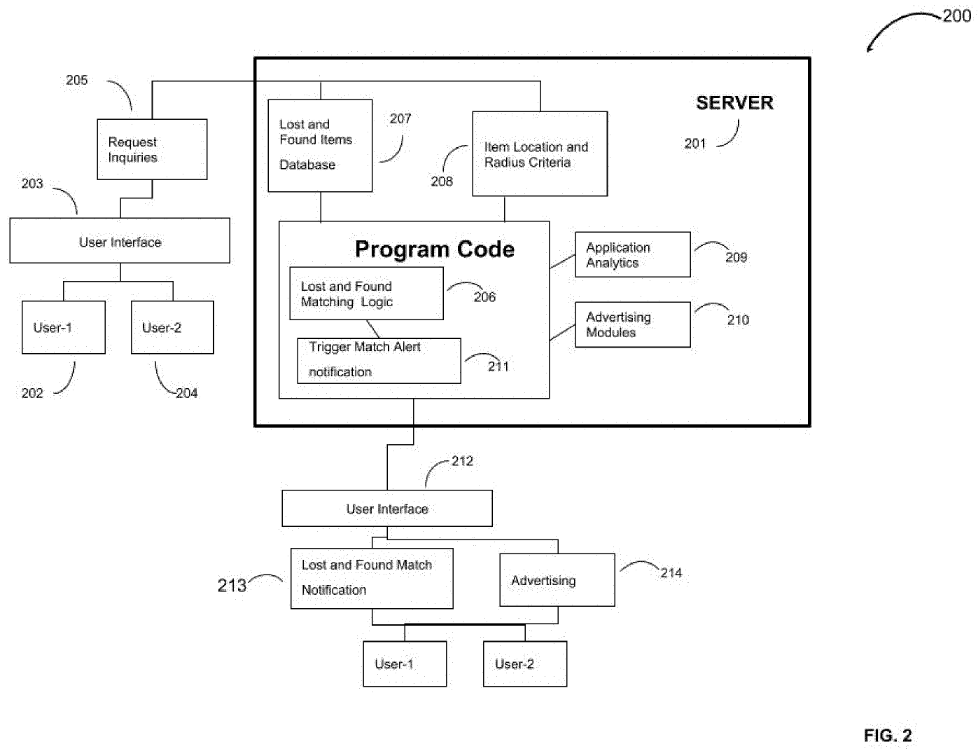

FIG. 2 illustrates a diagram 200 of the flow of data that is inputted into the lost and found application by users and processed by the server 201 to generate and send lost and found item notifications in accordance with an embodiment of the present disclosure. User-1 202 utilizes the User Interface 203 to enter in data about the lost object or User-2 204 utilizes the User Interface 203 to enter data about the found object. When the users are entering their information, the information essentially acts as a request 205 to the System to find matching users. The request is sent the Server 201 to apply matchmaking logic coding 206. The criteria needed to complete a request is if the user has lost an item or if the user is finder of an item and the type of item that has been lost or found which is stored in the database 207, and the location or estimated location of the lost or found item 208.

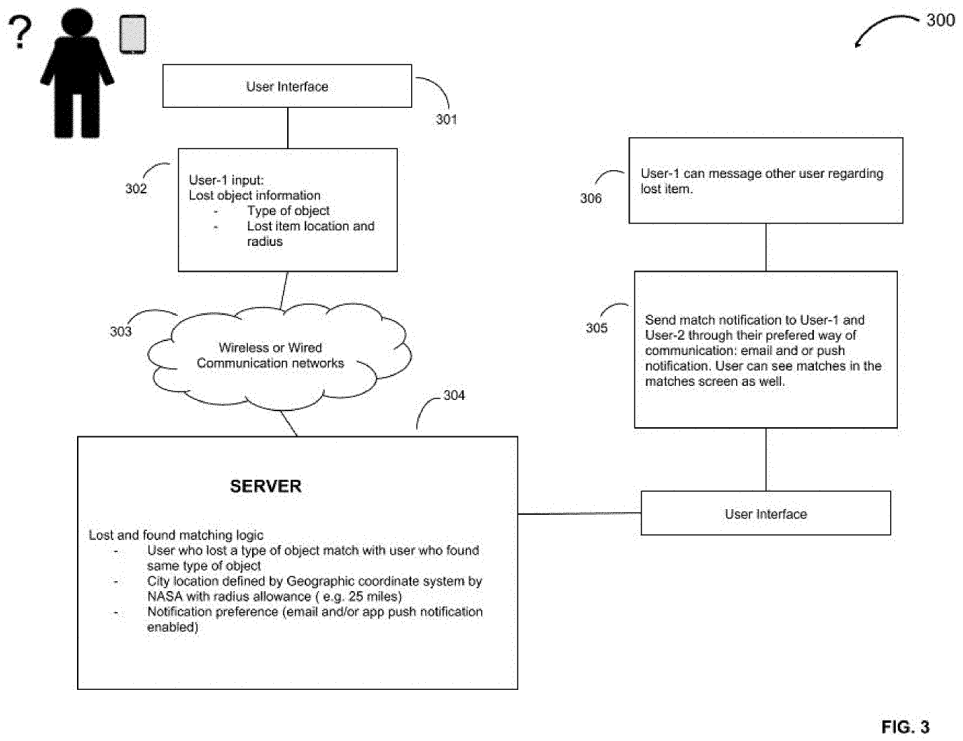

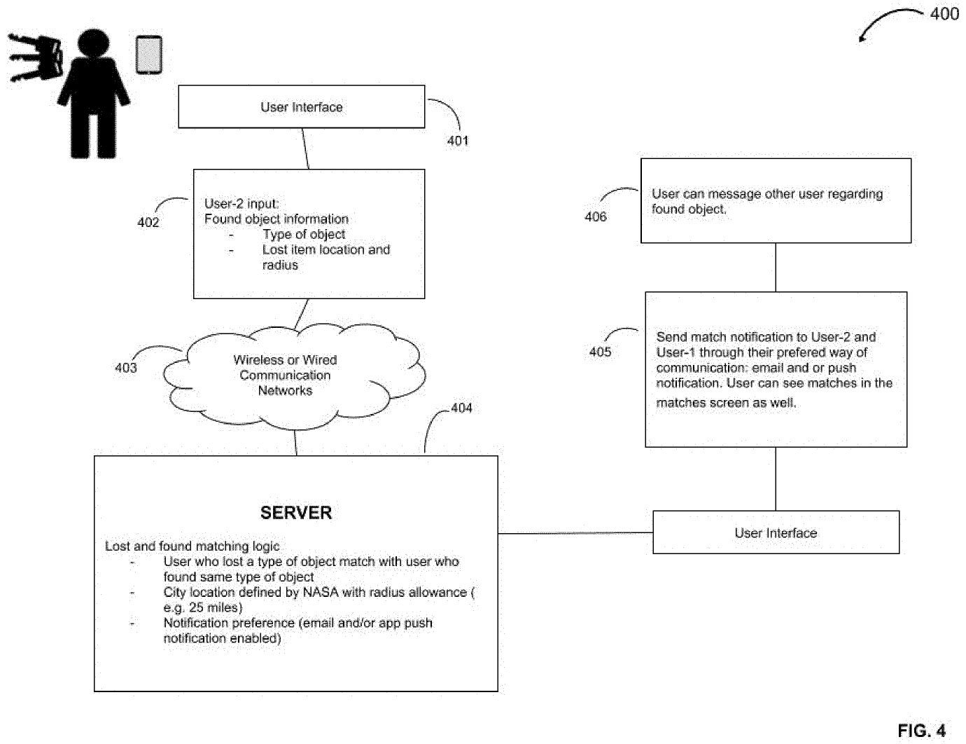

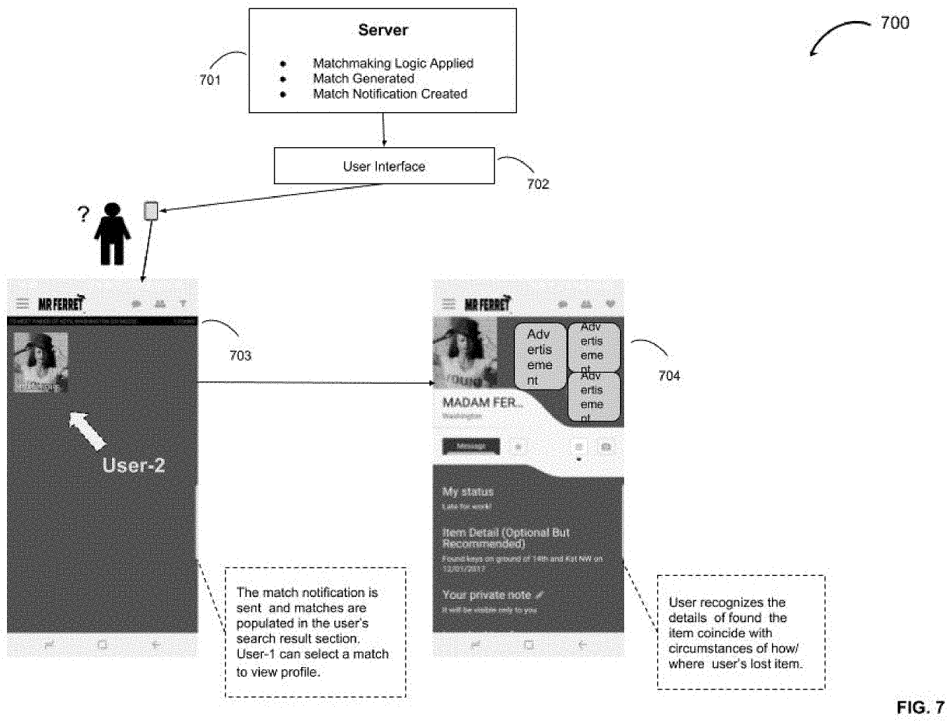

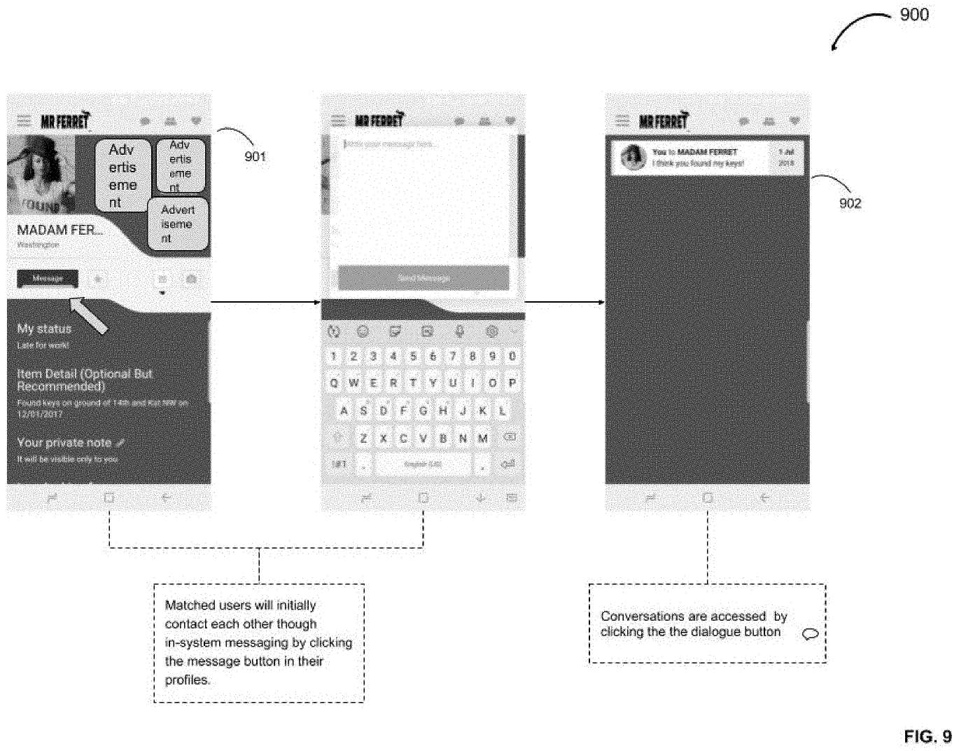

The server may be local or remote, and it processes the criteria with program code such as lost and found matchmaking logic 206. The lost and found matchmaking logic uses a complementary logic that determines item matches. The lost and found matching logic also incorporates the location of item 208. Exemplary operation of the lost and found logic is described more fully below in conjunction with FIG. 3 and FIG. 4. Application analytics 209 is incorporated in the program code to capture statistical data on the System's users. Advertisement may also be shown in the User Interface to the users, if a company has relevant services or goods to offer the user. The advertising module 210 is implemented in the server for the purpose of a relevant businesses to advertise to users 214 such as a locksmith for User-1. The advertising module's output is displayed on FIG. 7 and FIG. 9.

After a lost and found logic is complete the result of a match will trigger a match notification 211. This is sent back to the User Interface 212, and the Lost and Found Notification 213 is sent to the matching users according to their notification communication preferences. The notification communication preferences will be addressed in FIG. 11.

FIG. 3 is a flow diagram on how the data of User-1, who is searching for a lost item, is processed through the server which utilizes matchmaking logic, location radius criteria, and user notification preferences to generate match results and send notifications to matched users in accordance with an embodiment of the present disclosure. In emplary , User-1 uses a mobile device in order to input information in the user interface. In flow diagram 300, User-1 inputs the lost item information 302 in the user interface 301. The information necessary for the System to generate a match is the type of user-item relationship and the item's last known location. The information is provided to the Server 304 for processing through wired and wireless communication networks 303. In exemplary, User-1 can be a person who has lost their keys. The location will be a list of cities from which to choose. In certain embodiments, the mobile device is able to utilize an application version or mobile website version of the Lost and Found Matchmaking System.

The server utilizes the user-item relationship along with last known location details of the item to implement matchmaking logic created through program code. The location criteria is defined by cities that are already programmed into the system. The cities are defined by the geographic coordinate system of longitude and latitude. The longitude and latitude coordinates reflects NASA's definition of the longitudinal and latitudinal location of each city. In embodiments, a standard radius of a certain distance is automatically applied to the location by the System when the user initially registers. The radius creates a larger and more inclusive area of search and is used in the matchmaking logic. The radius can be later adjusted the user settings. This User setting will be addressed in FIG. 11.

After matchmaking logic is applied, the server then generates matches and triggers match notifications to be created 304. The server provides matched users notifications and results by sending a notification to all users in accordance to the users' notification preferences 305. The user can also view matches in the matches results section of the user interface. User-1 can use the in-application messaging system to contact a matched user regarding their lost object 306. The in-application messaging system will be addressed in FIG. 9.

FIG. 4 is a flow diagram on how the data of User-2, who has found a lost item, is processed through the server which utilizes matchmaking logic, location radius criteria, and user notification preferences to generate match results and send notifications to matched users in accordance with an embodiment of the present disclosure 400. In exemplary, User-2 can be a person who has found keys User-2 inputs the found item information 402 in the user interface 401. The information necessary for the System to generate a match is the type of user-item relationship and the item's found location. The information is provided to the Server 404 for processing through wired and wireless communication networks 403. The location will be a list of cities from which to choose. In emplary , User-2 uses a mobile device in order to input information in the user interface. In certain embodiments, the mobile device is able to utilize an application version or mobile website version of the Lost and Found Matchmaking System.

The server utilizes the user-item relationship along with last known location details of the item to implement matchmaking logic created through program code. The location criteria is defined by cities that are already programmed into the system. The cities are defined by the geographic coordinate system of longitude and latitude. The longitude and latitude coordinates are reflects NASA's definition of the longitudinal and latitudinal location of each city. In embodiments, a standard radius of certain distance is automatically applied to the location by the System during initial registration. The radius creates a larger and more inclusive area of search and is used in the matchmaking logic. The radius can be later adjusted the user settings. This User setting will be addressed in FIG. 11.

After matchmaking logic is applied, the server then generates matches. The server triggers match notifications to be created 404. The server provides matched users notifications and results by sending a notification to all matched users in accordance to the users' notification preferences 405. The user can also view matches in the matches results section of the user interface. User-2 can use the in-application messaging system to contact a matched user regarding their lost object 406. The in-application messaging system will be addressed in FIG. 9.

FIG. 5 shows an exemplary user interface on a mobile device entering necessary lost item data in accordance with an embodiment of the present disclosure 500. User-1 initially registers by building a basic profile by entering certain criteria. User-1 will identify what type of user they are by choosing if they are a “finder” of a predetermined object or a person who has lost a predetermined object. In exemplary, User-1 501 has selected that they are missing keys 502. Through matchmaking logic, this will signal the application to automatically match the user with complementary results. In exemplary, if the user is missing keys, it will automatically match them with users who have found keys. This is fundamental variable of the System's matchmaking logic. The other essential variable for matchmaking completion is item location information.

The User-1 will then select the city and state in which the item was lost 503. It should be noted that the user has selected District of Columbia as the location, if the user wanted to select a non independent city, they would have to pick the state first and then the city within the state. In all embodiments, a search radius of a preset distance is initially utilized upon user registration. The city is defined by a geographic coordinate system of longitude and latitude disclosed by NASA. The city is treated as the center of the radius.

The user item information and the location information is sent to the server for storage and processing 504. The matchmaking logic process will only include user-item relationship complementary matches within the location area defined by the location and the radius. After creating the profile, the user can go into their profile settings to change the city in addition to the location radius of searching for matching users.

FIG. 6 shows an exemplary user interface on a mobile device entering necessary lost item data in accordance with an embodiment of the present disclosure. In the interface 600, User-2 initially registers by building a basic profile by entering certain criteria. User-2 will identify what type of user they are by choosing if they are a “finder” of a predetermined object or a person who has lost a predetermined object . In emplary, User-2 601 has selected that they have found keys 602. Through matchmaking logic, this will signal the application to automatically match the user with complementary results. In exemplary, if the user has found keys, it will automatically match them with users who have lost keys. This is fundamental variable of the System's matchmaking logic. The other essential variable for matchmaking completion is item location information.

The User-2 will then select the city and state in which the item was found 603. It should be noted that the user has selected District of Columbia as the location, if the user wanted to select a non independent city, they would have to pick the state first and then the city within the state. In all embodiments, a search radius of a preset distance is initially utilized upon user registration. The city is defined by a geographic coordinate system of longitude and latitude disclosed by NASA. The city is treated as the center of the radius.

The user item information and the location information is sent to the server for storage and processing 604. The matchmaking logic process will only include user-item relationship complementary matches within the location area defined by the location and the radius. After creating the profile, the user can go into their profile settings to change the city in addition to the location radius of searching for matching users.

FIG. 7 shows an exemplary output of match notification from the Server to the user interface of the user who has lost an item and has been matched with a user who has found that said item with an embodiment of the present disclosure. A match list is generated by the server 701 and then sent to the user interface 702 for User-1 to view. The user then has the ability to view matched users' profile to confirm match in accordance with an embodiment of the present disclosure.

The newest match will be first on the list of matches. In ideal embodiments, the match notification is sent from the server to the User Interface and is reflective of the results that are shown in the User Interface Results Section 703. Users matched with User-1 will receive a notification that they have a new match as well. When the user selects the match notification, the newest match will be first on the list of matches in the match results screen. This will be demonstrated in FIG. 9.

User-1 can click on the matched users' picture to view the profile 704 for verifying detailed information about the found item before contacting the user. It should be noted that in all embodiments, users in their own profile have the ability to freely type in a detailed description of the item and the circumstances in which the item was lost or found. This information is stored in the server and is displayed in their profile. The optional item detailed information does not affect the matchmaking logic or match results. It exists solely to aide a user in confirming matches before attempting to contact matched users. The method of contacting the users will be addressed in FIG. 9.

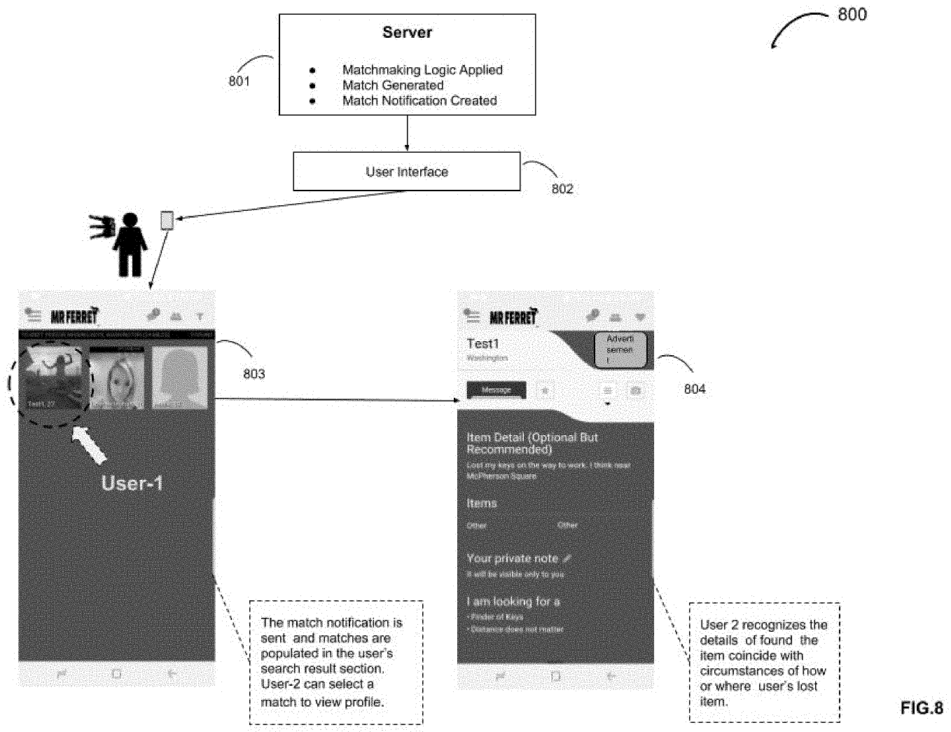

FIG. 8 shows an exemplary output of match notification from the server to the user interface of the user who has found an item and has been matched with users who have lost that said item within the location area. A match list is generated by the server 801 and then sent to the user Interface 802 for User-2 to view. User-2 then has the ability to view matched users' profiles to confirm match in accordance with an embodiment of the present disclosure.

The newest match will be first on the list of matches in the match results section. In ideal embodiments, the match notification is sent from the server to the User Interface and is reflective of the results that are shown in the User Interface Results Section 803. User-1 matched with User-2 and has also received a notification that they have a new match as shown in FIG. 7. In embodiments, the match notification sent from the Server to the User Interface and is reflective of the results that are shown in the User Interface Results Section 803.

User-2 can click on the matched users' picture to view the profile 804 for verifying item detail information about the lost or found item before contacting the user. It should be noted that in all embodiments, users in their own profile have the ability to freely type in a detailed description of the item and the circumstances in which the item was lost or found. This information is stored in the server and is displayed in the profile. The optional item detailed information does not affect the matchmaking logic or match results. It is solely to aide a user in confirming matches before attempting to contact matched users. The method of contacting the users will be addressed in FIG. 9.

FIG. 9 shows an exemplary user interface in which users can contact each other through in-system messaging in accordance with an embodiment of the present disclosure. This FIG. 900 displays how matched users will initially contact each other though in-system messaging by clicking the message button in their profile 901. Message dialogues will be stored in the user-interface message section of the System 902 and also in the Server. The users will also receive notification that they have a new message. Outside of the System, a push notification for the mobile or tablet application of the system and email notification is utilized. Inside the System, in the User Interface, the notification of a new message is indicated. The users will click on the message indicator to view the message and respond accordingly.

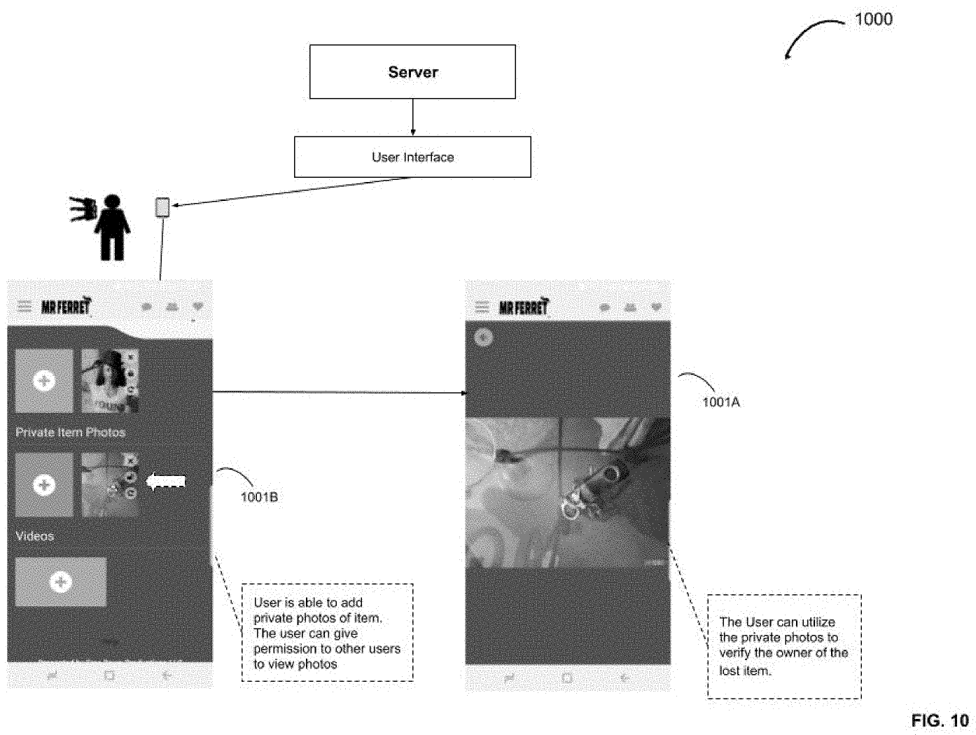

FIG. 10 shows an exemplary user interface in which a user who has found or lost an item can maintain private pictures of the item in their profile for confirmation of the identity of the owner or possessor of the item in accordance with an embodiment of the present disclosure 1000. When a user is matched with another user, the user can upload a picture of the item 1001A and give limited view access to the picture by placing it in the Private Item Photos section of the user profile 1001 B. The user can share it with selected matches to confirm the owner or possessor of the item. The user can also ask the matched users detailed questions about the item and utilize the picture as a reference before sharing the private picture of the item with the matched user. The use of the private item photo is of the photo owner's discretion.

FIG. 11 displays how users can edit their search criteria and the mode at which they receive notification within the application after establishing an initial profile with an embodiment of the present disclosure 1100. In the Settings Section, users can edit the type of user-item relationship. In an embodiment, the setting section also allows the user the ability to choose multiple user-item relationships with whom to identify 1101. Like a single user-item relationship, a multiple user-item relationships inquiry generates respected matches, and the notifications are sent to the matched users accordingly. The matches appear in the match results section of the user interface as seen in FIG . 7 and FIG. 8. Additionally in the Settings Section, the System allows the users to tailor the manner in which they are contacted about matches 1103. Users can also edit the city where they believe the object was lost or was found as well as editing the radius of the search with the geographic center being the chosen city 1102.

What is claimed is:

1. A method in creating and sending lost and found item match notifications for matched users who have lost or found items though a lost and found matchmaking notification system, the method comprising:
receiving information from a user device detailing the user-item relationship;
receiving information on where the item was believed to be lost, or where the item was found ;
using matchmaking logic by implementing complementary user-item matching code and mutually inclusive location radius calculation to determine user match completion and trigger user match notification; and
providing notification to user devices of complementary matched users created through matchmaking logic in program code.

2. The method of claim 1, further comprising of a user-Interface of the system lost item information from a user device.

3. The method of claim 1, further comprising of a user- interface of the system found item information from a user device.

4. The method of claim 1, wherein a lost item match notification is sent to the user-interface of the system.

5. The method of claim 1, wherein a found item match notification is sent to the user-interface of the system.

6. The method of claim 1, wherein the initial information entered in by the user also creates a preliminary profile in the system.

7. The method of claim 1, wherein the system providing a list of matched users in the match results section of the user-interface.

8. The method of claim 7, wherein the system allows users to select matched users on the results section to view matched user profiles where item detail information is held for verification purposes.

9. The method of claim 7, wherein the system provides in-system messaging for matched users from the match results.

10. The method of claim 6, wherein the user profile information includes private item photos for discretionary disclosure to confirm ownership or possession of item.

11. The method of claim 1, wherein the user settings controls the methods at which the user receives match notification and information.

12. A server for the purpose of maintaining a database of user-item relationship, item lost location, item found location, item detail information, item photos, and user communication dialogues through user device input from the system's user-interface though wired or wireless networks.

13. The server of claim 12, wherein lost item information is received.

14. The server of claim 12, wherein found item information is received.

15. The server of claim 12, wherein the location of the lost item is the believed known last location of the item.

16. The server of claim 12 wherein the location of the found item is the location where the item was found.

17. The server of claim 12, wherein the location is defined by city with a preset location radius during initial user registration.

18. The server of claim 17, wherein the location is defined by longitude and latitude coordinates provided by the national aeronautics and space administration.

19. The server of claim 12, processing and maintaining database information of user-item relationship and location of the lost or found item through matchmaking logic program code.

20. The server of claim 19, establishing user lost and found matches and triggering match notification to be be sent to each matched user.
